(19) United States
(12) Patent Application Publication
(10) Pub. No.: US 2013/0120398 A1
(43) Pub. Date: May 16, 2013

(54) INPUT DEVICE AND METHOD FOR AN ELECTRONIC APPARATUS

(71) Applicants: Gregory Ian SMYTH, Mississauga (CA); Paul Dwight HAIST, Mississauga (CA); Iaacov Coby SEGALL, Mississauga (CA); Mark FOUNTAIN, Earlsfield (GB); Edward Anthony HACKETT, Surbiton (GB); Benjamin James CULLEN, Baulkham Hills (AU)

(72) Inventors: Gregory Ian SMYTH, Mississauga (CA); Paul Dwight HAIST, Mississauga (CA); Iaacov Coby SEGALL, Mississauga (CA); Mark FOUNTAIN, Earlsfield (GB); Edward Anthony HACKETT, Surbiton (GB); Benjamin James CULLEN, Baulkham Hills (AU)

(73) Assignee: PSION INC., Mississauga (CA)

(21) Appl. No.: 13/293,363

(22) Filed: Nov. 10, 2011

(51) Int. Cl. G06T 13/80; G09G 5/00

(52) U.S. Cl. 345/473; 345/156

(57) ABSTRACT

The present specification teaches an input device and method for electronic apparatus. The input device can be based on one or more force sensitive input devices, such as force sensitive resistors. The electronic apparatus includes an output device such as a display. A processor is configured to receive input from the input device and to control the display or other output device. In certain implementations, the display is controlled to generate a first graphical object that is associated with an instruction. The processor is configured to generate a second graphical object in response to an input received from the force sensitive input device that corresponds with the instruction.

### FIELD

The present invention relates generally to an electronic apparatus and more specifically relates to an input device and method for electronic apparatus.

### BACKGROUND

The computer-age is still relatively new, and technological innovation for computers has seen a greater emphasis on increasing hardware resources such as memory and processing, or efficiently utilizing those resources when they are scarce. With the maturation of hardware and software programming techniques, increasing efforts are being made to improve usability. As but one recent example, tablet computers have recently had a massive impact on the configurations of electronic apparatuses available on the market, and have the potential to supplant a certain amount of the traditional laptop and notebook market. Much of that impact has been attributed to usability, as tablet computers frequently incorporate voice recognition, touch screens and accelerometers, eschewing the traditional keyboard and mouse.

The proliferation of small, mobile computing form factors has also made it difficult to rely on the traditional keyboard and mouse as input devices. Accordingly, touch screens are commonly deployed and software is responsive to various swipe gestures involving the sweeping of the thumb or fingers over the touch screen surface. Conveniently, swipe gestures can obviate the need for a mouse, trackpad or other pointing device. However, not all mouse functionality can be elegantly substituted with swipe gestures. For example, implementing the “right click” or “scroll wheel” functionality using swipe gestures has resulted in the development of highly complex swipe gestures that can require the use of multiple fingers, thereby interfering with the very usability gains originally contemplated by the deployment of swipe gestures.

Further, such swipe gestures inherently require portions of the touchscreen to be covered with the finger, or fingers, used in making the gesture. Thus, when making a user interface gesture, at least some part of display the user is interacting with is obscured from their view. This can result in some level of awkwardness being introduced to user interface and, in some cases, the occurrence of non-intuitive results and/or user confusion.

### SUMMARY OF THE INVENTION

An object of the present invention is to obviate or mitigate at least one disadvantage of the prior art.

Aspects of the present invention provide an input device and method for electronic apparatus. The input device can be based on one or more force sensitive input devices, such as force sensitive resistors. The electronic apparatus includes an output device such as a display. A processor is configured to receive input from the input device and to control the display or other output device. In certain implementations, the display is controlled to generate a first graphical object that is associated with an instruction. The processor is configured to generate a second graphical object in response to an input received from the force sensitive input device that corresponds with the instruction.

An aspect of the present invention provides a method for controlling a display of an electronic apparatus in response to an input from a force sensitive input device (FSID) comprising: controlling the display to generate a first graphical object; associating the first graphical object with an instruction; receiving an input representing an applied force at the FSID; determining receipt of the instruction based on the input from the FSID; and, controlling the display to generate a second graphical object different from the first graphical object in response to the determined instruction.

The method can further comprise performing an additional instruction in association with the input.

The additional instructions can comprise one of an unlock command, a zoom command or a pan command.

The graphical object can be an animation of the first graphical object.

The associating can comprise associating the first graphical object with a plurality of input instructions from the FSID and wherein the determining comprises determining one of a plurality of potential instructions based on a match between the input and one of the plurality of input instructions.

The FSID can be a force sensitive resistor.

The FSID can comprise a plurality of FSIDs.

The input can comprise a swipe gesture having a directional component.

The input can comprise a rub gesture having a directional component and a variable force component.

The FSIDs can be implemented using a strip force sensitive resistor.

The plurality of FSIDs can be coplanar with the display.

Another aspect of the invention provides a electronic apparatus comprising a display; a processor connected to the display for controlling the display to generate a first graphical object and for associating the first graphical object with an instruction; a force sensitive input device (FSID) connected to the processor for providing input to the processor that represents an applied force to the FSID; and, the processor further configured to determine receipt of the instruction based on the input and to control the display to generate a second graphical object different from the first graphical object in response to the instruction.

Another aspect of the invention provides an electronic apparatus comprising an output device; a processor connected to the display for controlling the device to generate a first output object and for associating the first output object with an instruction; a force sensitive input device (FSID) connected to the processor for providing input to the processor that represents an applied force to the FSID; and, the processor further configured to determine receipt of the instruction based on the input and to control the output device to generate a second output object different from the first output object in response to the instruction.

### BRIEF DESCRIPTION OF THE DRAWINGS

Various embodiments of the present invention will now be discussed, by way of example only, with reference to the attached Figures in which:

FIG. 1 is a schematic representation of a front view of a portable electronic apparatus having a force sensitive input device (FSID).

FIG. 2 is a block diagram of the electronic components of the device shown in FIG. 1.

FIG. 3 is a schematic representation of FSID that can be used in the device of FIG. 1.

FIG. 4 shows the FSID of FIG. 3 in an off position.

FIG. 5 shows the FSID of FIG. 3 in a first position carrying a first level of power through to the processor of FIG. 2.

FIG. 6 shows the FSID of FIG. 3 in a second position carrying a second level of power, greater than the first level of power, through to the processor of FIG. 2.

FIG. 7 shows the device of FIG. 1 with a schematic representation of the device executing an example application.

FIG. 8 shows a flow-chart depicting a method of processing force-variable input.

FIG. 9 shows the device of FIG. 7 during example performance of certain blocks of the method of FIG. 8.

FIG. 10 shows the device of FIG. 7 during example performance of certain blocks of the method of FIG. 8.

FIG. 11 shows the device of FIG. 7 during example performance of certain blocks of the method of FIG. 8.

FIG. 12 shows a variation of the device of FIG. 1.

FIG. 13 shows the device of FIG. 12 during example performance of certain blocks of the method of FIG. 8.

FIG. 14 shows another variation of the device of FIG. 1.

FIG. 15 shows the device of FIG. 12 during example performance of certain blocks of the method of FIG. 8.

FIG. 16 shows the device of FIG. 12 during example performance of certain blocks of the method of FIG. 8.

FIG. 17 shows another variation of the device of FIG. 1.

FIG. 18 shows the device of FIG. 17 after performance of certain blocks of the method of FIG. 8.

FIG. 19 shows the device of FIG. 17 after performance of certain blocks of the method of FIG. 8.

FIG. 20 shows the device of FIG. 17 after performance of certain blocks of the method of FIG. 8.

FIG. 21 shows another variation of the device of FIG. 1.

FIG. 22 shows another variation of the device of FIG. 1.

FIG. 23 shows another variation of the device of FIG. 1.

FIG. 24 shows another variation of the device of FIG. 1.

FIG. 25 shows a rear view of the device of FIG. 24.

FIG. 26 shows a front view of the device of FIG. 1 with the FSID array on the rear of the device shown in dashed-lines.

### DETAILED DESCRIPTION OF THE EMBODIMENTS

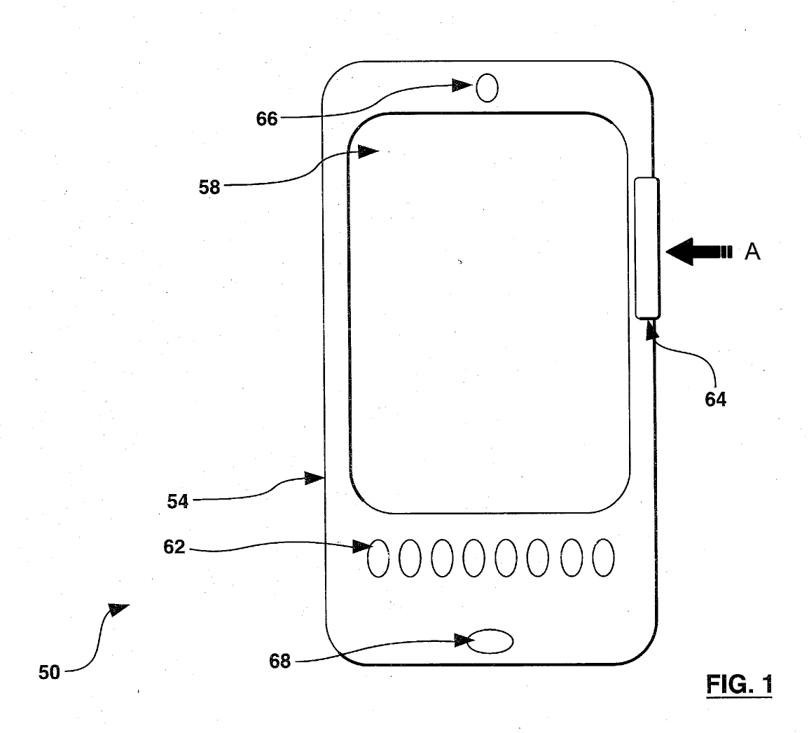

Referring now to FIG. 1, shows a schematic representation of a portable electronic apparatus indicated generally at 50. It is to be understood that portable electronic apparatus 50 is an example, and it is to be understood that a variety of different portable electronic apparatus structures are contemplated. Indeed variations on portable electronic apparatus 50 can include, without limitation, a cellular telephone, a portable email pager, a camera, a portable music player, a portable video player, a portable video game player. Other contemplated variations include apparatus which are not necessarily portable, such as desktop computers, laptop computers, note book computers, or console computers mounted to or within a vehicle dashboard.

As shown in FIG. 1, apparatus 50 comprises a chassis 54 that supports a display 58. Display 58 can comprise one or more light emitters such as an array of light emitting diodes (LED), liquid crystals, plasma cells, or organic light emitting diodes (OLED). Other types of light emitters are contemplated. Chassis 54 also supports a keyboard 62. It is to be understood that this invention is not limited to any particular structure, spacing, pitch or shape of keyboard 62, and the depiction in FIG. 1 is an example. For example, full or reduced “QWERTY” keyboards are contemplated. Other types of keyboards are contemplated. Apparatus 50 also comprises at least one force sensitive input device 64. Hereafter, force sensitive input device 64 may also be referred to as FSID 64. Force sensitive input device 64 is generally configured to provide a varying input signal to processor 100. The input signal varies according to the amount of force applied to FSID 64. The direction and amount of force represented as arrow “A” in FIG. 1, and will be discussed in greater detail below. In a present embodiment, apparatus 50 also comprises a speaker 66 for generating audio output, and a microphone 68 for receiving audio input.

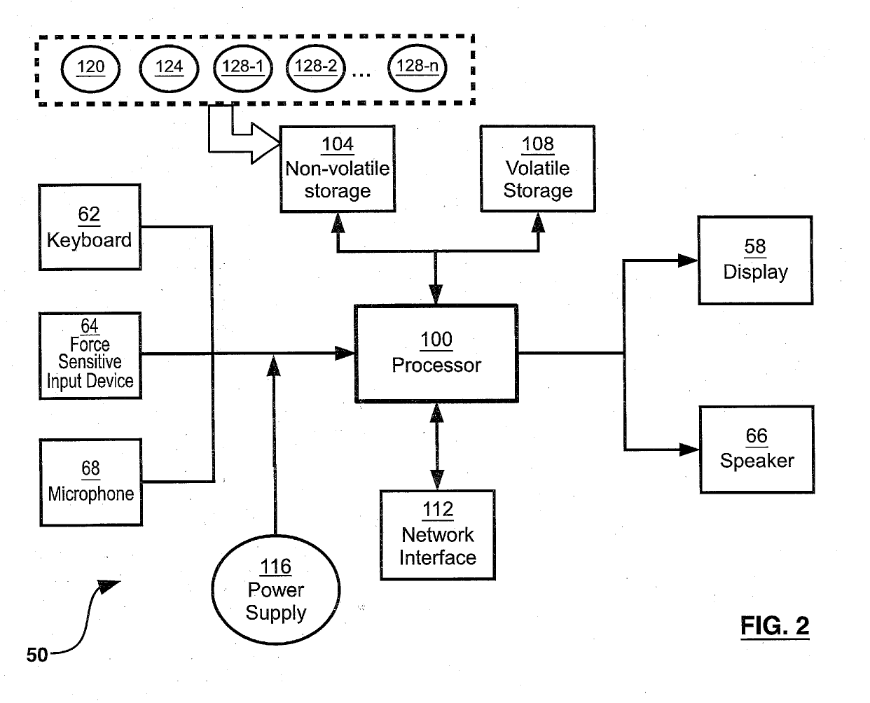

FIG. 2 shows a schematic block diagram of the electronic components of apparatus 50. It is to be emphasized that the structure in FIG. 2 is a non-limiting example. As shown in FIG. 2, the block components of apparatus 50 contemplate a plurality of input devices which in a present embodiment includes keyboard 62, FSID 64, and microphone 68. Inputs from keyboard 62, FSID 64 and microphone 68 are received at processor 100. Processor 100 can be implemented according to any desired configuration, such as a single processor, or a plurality of processors or one or more multi-core processors. Generally speaking, processor 100 can be configured to execute different programming instructions responsive to the input signals received via the various input devices. To fulfill its programming functions, processor 100 is also configured to communicate with one or more storage units, implemented in the present embodiment as a non-volatile storage unit 104 (e.g. Erase Electronic Programmable Read Only Memory (“EEPROM”), Flash Memory) and a volatile storage unit 108 (e.g. random access memory (“RAM”). Programming instructions that implement the teachings of apparatus 50 as described herein are typically maintained, persistently, in non-volatile storage unit 104 and used by processor 100 which makes appropriate utilization of volatile storage 108 during the execution of such programming instructions.

Processor 100 in turn is also configured to control display 58 and speaker 66, also in accordance with different programming instructions, such control optionally being in response to different input received from the various input devices.

Processor 100 also connects to a network interface 112, which can be implemented in a present embodiment as a radio configured to communicate over a wireless link, although in variants apparatus 50 can also include a network interface for communicating over a wired link. Network interface 112 can thus be generalized as a further input/output device that can be utilized by processor 100 to fulfill various programming instructions. It will be understood that interface 112 is configured to correspond with the network architecture that defines such a link. Present, commonly employed network architectures for such a link include, but are not limited to, Global System for Mobile communication (“GSM”), General Packet Radio Service (“GPRS”), Enhanced Data Rates for GSM Evolution (“EDGE”), 3G, High Speed Packet Access (“HSPA”), Code Division Multiple Access (“CDMA”), Evolution-Data Optimized (“EVDO”), Institute of Electrical and Electronic Engineers (IEEE) standard 802.11, Bluetooth™ or any of their variants or successors. It is also contemplated each network interface 112 can include multiple radios to accommodate the different protocols that may be used to implement different types of links.

Apparatus 50 also includes a power supply 116 which can be implemented as a battery or other electrical power source. For convenience, in FIG. 2, power supply 116 is shown as connecting to a bus that inputs into processor 100, but it is to be understood that power supply 116 is an available source of electrical energy for all of the components in apparatus 50.

As will become apparent further below, apparatus 50 can be implemented with different configurations and form-factors other than that which are expressly described herein. For example, certain input devices can be omitted (e.g. keyboard 62), or other input devices can be included (e.g. a touch-sensitive membrane over display 58). Likewise certain output devices can be omitted, or other output devices can be included (e.g. haptic devices). Furthermore, network interface 112 can also be eliminated. However, a common feature of any apparatus 50 used to implement the teachings of this invention includes at least one FSID 64 and accompanying processing and storage structures.

In a present embodiment, device 54 is also configured to maintain, within non-volatile storage 104, a driver 120; and at least one application 124. As will be explained further below, any one or more of driver 120 and application 124 can be pre-stored in non-volatile storage 104 upon manufacture of apparatus 50, or downloaded or updated via network interface 112 and saved on non-volatile storage 104 at any time subsequent to manufacture of apparatus 50. One or more additional software modules 128-1, 128-2, . . . , 128-n such as operating system(s), additional drivers, additional applications, and the like, can also be stored within non-volatile storage 104, for use by processor 100, as needed or desired to provide functionality to apparatus 50. (Note that additional software modules 128-1, 128-2, . . . , 128-n are hereafter referred to generically as software module 128, and collectively as software modules 128. This nomenclature is used elsewhere herein.)

Processor 100 is configured to execute application 124, making use of driver 120 and other software modules 128 as needed. In one general aspect of this invention, as will be explained further below, processor 100 is configured, while executing application 124, to control various output devices (such as display 58 or speaker 66) in response to varying input signals received from FSID 64 that change according to the amount of force applied along arrow “A” in FIG. 1.

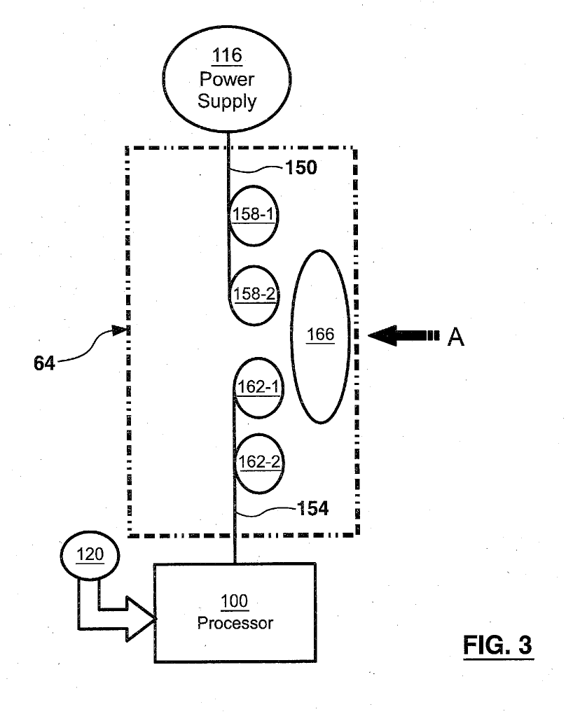

Referring now to FIG. 3 a schematic representation of FSID 64 is shown in context with power supply 116 and processor 100, isolated from other components in apparatus 50. The representation in FIG. 3 is non-limiting and other implementations of FSID 64 are contemplated and will become apparent to the skilled reader with the benefit of this specification. FSID 64 thus comprises an input line 150 that connects to power supply 116, and an output line 154 that connects to processor 100. Input line 150 includes a first plurality of contacts 158, and output line 154 includes a second plurality of contacts 162. FSID 64 also comprises an actuator 166 which is mechanically biased in a direction away from contacts 158 and contacts 162, such that when no force is applied to actuator 166 along the path indicated at arrow A, current is unable to flow from power supply 116 to processor 100.

FSID 64 can be implemented using different technologies. For example, FSID 64 can be implemented using a force sensing resistor, including variants on the range of force sensing resistors (FSR) offered by Interlink Electronics Inc. 546 Flynn Road, Camarillo, Calif. 93012, USA. Such FSRs can be made up of four layers including: a top mylar layer with a conductive bottom; a spacer to separate the top layer and the one below; another piece of mylar with silver ink printed thereon; and an adhesive layer on the bottom for attachment to a housing such as chassis 54. The silver ink is not flat, but rather comprises a plurality of particles having different peak heights. At low forces, only the tallest particles make contact with the top mylar layer. As contact force increases, more and more of the particles make contact with the top mylar layer. Therefore, resistance is inversely proportional to the force applied. It is to be emphasized however that other ways of implementing FSID 64, other than through FSRs such as strain gauges implemented with microelectromechanical systems (MEMs) or other technologies, are contemplated.

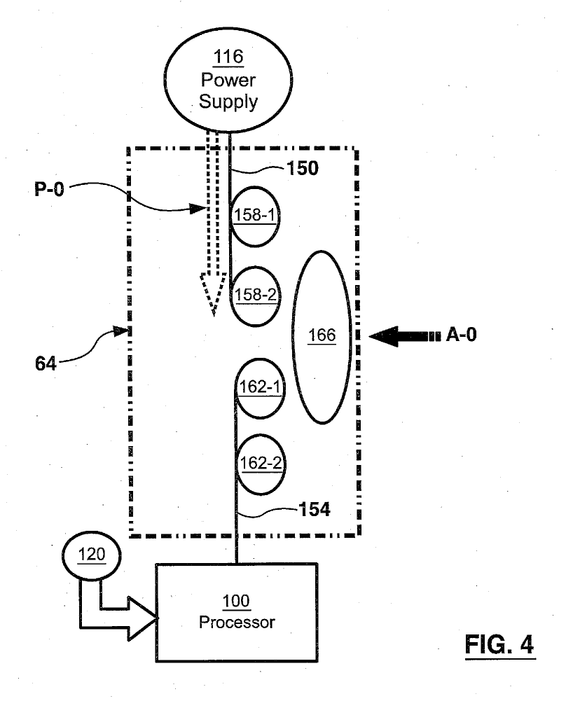

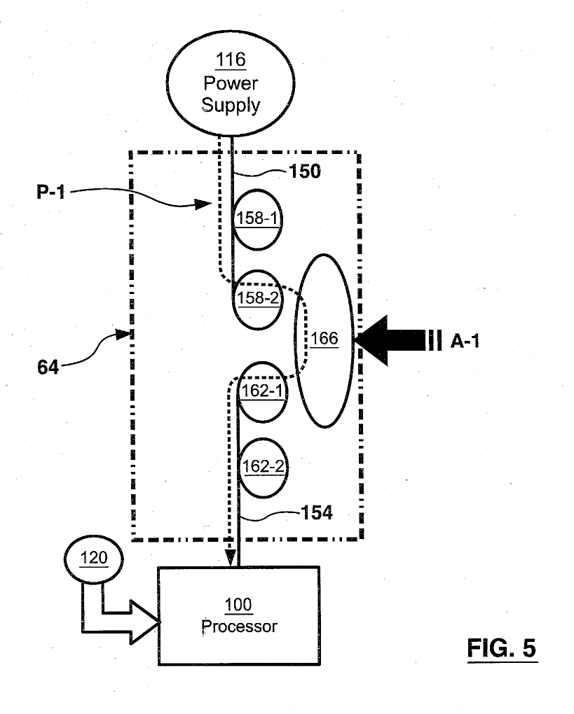

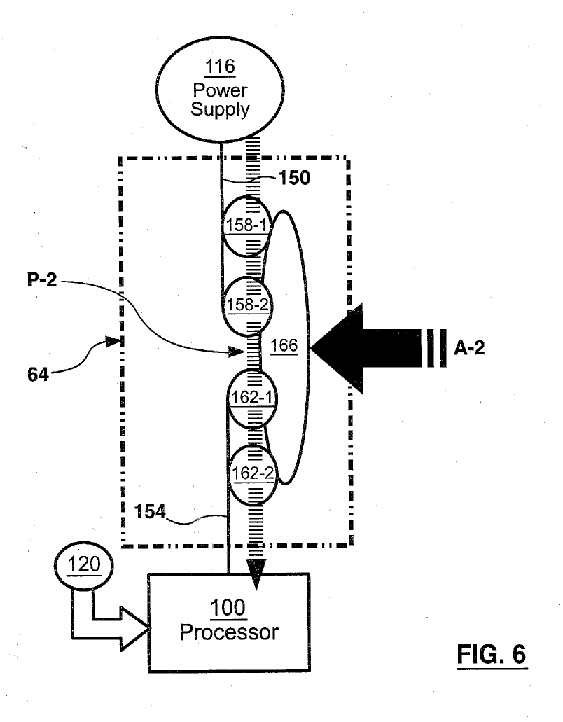

FIG. 4, FIG. 5, and FIG. 6 are based on the schematic in FIG. 3, and show non-limiting examples of FSID 64 in various states of use. In FIG. 4, no force (or very little) is applied to actuator 166, and this is represented as such by the labeling the force arrow with the reference A-0 in FIG. 4, and by showing force A-0 as, having no contact with actuator 166. As noted above with respect to the discussion of FIG. 3, in this state no electrical power (P-0) can pass from power supply 116 to processor 100.

In FIG. 5, a first amount of force is applied to actuator 166, and this fact is represented as such by the labeling the force arrow with the reference A-1 in FIG. 5. In FIG. 5, force A-1 results in electrical contact being made between source contact 158-2 and source contact 162-1 via actuator 166, resulting in a first level of power (P-1) now being permitted to flow from power supply 116 to processor 100.

In FIG. 6, a second amount of force is applied to actuator 166, and this fact is represented as such by labeling the arrow with the reference A-2 in FIG. 6. Force A-2 is a greater level of force than force A-1. In FIG. 6, force A-2 results in electrical contact between all source contacts 158 and all drain contacts 162, resulting in a second level of power (P-2) now being permitted to flow from power supply 116 to processor 100. Note that just as force A-2 is greater than force A-1, power level P-2 is greater than power level P-1.

The amount by which power level P-2 is greater than power level P-1, can, but need not, be linearly proportional to the increase in force A-2 over force A-1. The general principle is that the amount of power received at processor 100 from power supply 116 increases with the amount of force applied to actuator 166. In general, it is also to be noted that FSID 64 is not limited to the three discrete states shown in FIG. 3, FIG. 4, FIG. 5 and FIG. 6. In practice, it is contemplated that a large number of source contacts 158 and a large number of drain contacts 162 are provided, such that a plurality of states exist whereby the amount of power received at processor 100 is proportional (though not necessarily linearly proportional) to the amount of force applied to actuator 166. It will now be apparent that one or more of source contacts 158, drain contacts 162 and actuator 166 are semi-conductors, such that more power is permitted to flow through cumulative connections between these components.

It will now be understood by the skilled reader that the power signals received at processor 100 in relation to FIG. 3, FIG. 4, FIG. 5 and FIG. 6 reflect raw data that can be processed by driver 120 and passed to an application, such as application 124, for further processing.

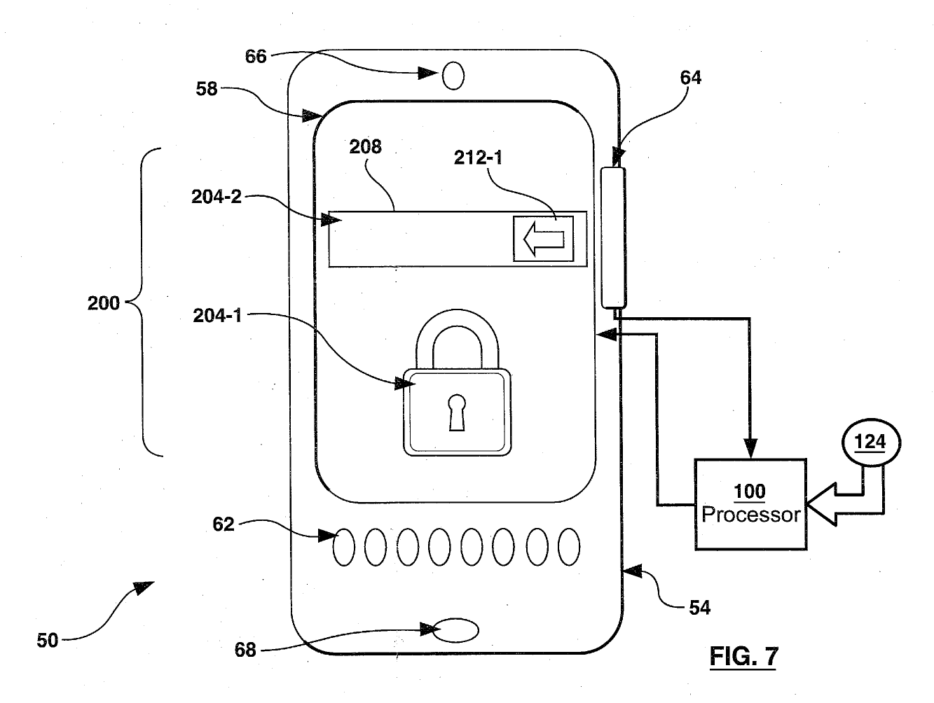

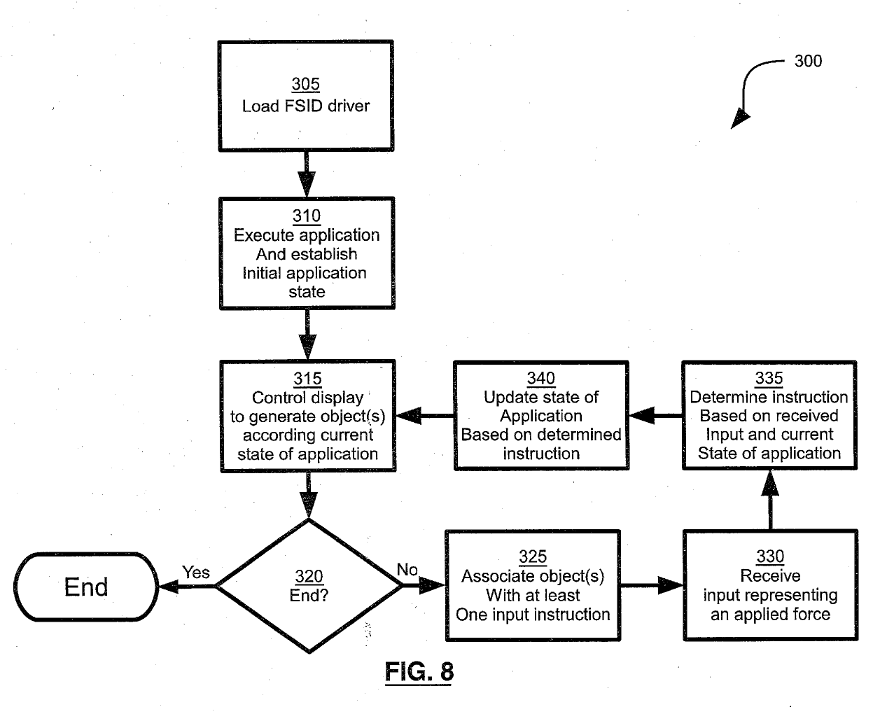

Referring now to FIG. 7, display 58 of apparatus 50 is shown displaying graphical output of a non-limiting example of application 124. Application 124 is configured to place apparatus 50 in a “locked” state to restrict inadvertent or unauthorized use of apparatus 50, until an acceptable “unlock” instruction is received. For convenience, processor 100 is shown as controlling display 58 and receptive to any input from FSID 64. In this example, application 124 includes programming instructions for generating an interactive lock screen 200 on display 50. Lock screen 200 comprises two graphical objects 204 in the form of a padlock icon object 204-1 and an unlock slider 204-2. In the present embodiment, padlock icon object 204 is fixed and inanimate, but unlock slider 204-2 is interactive. Unlock slider 204-2 comprises a graphical representations of a channel 208 and a follower 212. As will be discussed further below, processor 100 is configured to animate follower 212 such that follower 212 appears move from the right side of channel 208 to the left side of channel 208 (as viewed from the perspective in FIG. 8) according to the amount of force applied to FSID 64.

Referring now to FIG. 8, a flowchart depicting a method for controlling a display in response to input is indicated generally at 300. Method 300 is one way in which processor 100 can be configured. It is also to be emphasized the method 300 can be varied and that method 300 need not be performed in the sequence as shown, hence the reference to “blocks” rather than “steps”. Indeed some blocks may be performed in parallel. To assist in discussion of method 300, a specific example to its performance will be discussed in relation to apparatus 50, and application 128 from FIG. 7.

Block 305 comprises loading an FSID driver. In apparatus 50, block 305 can be implemented loading driver 120 into processor 100 such that processor 100 becomes configured to obtain raw data from FSID 64 and to provide that raw data to any application that executes on processor 100. For clarity, such raw data accumulation is consistent with the teachings in relation to FIG. 4, FIG. 5 and FIG. 6.

Block 310 comprises executing an application. In apparatus 50, block 310 can be implemented by processor 100 loading and executing application 124.

Block 315 comprises controlling the display of the device to generate object(s) according to the current state of the application. For illustrative purposes, it will be assumed that apparatus 50 is in the “locked” state and accordingly, processor 100 will control display 50 to generate the view shown in FIG. 7.

Block 320 comprises a decision box as to whether to end the method. A “yes” determination leads to an End box whereby method 300 ends; a “no” determination leads to block 325. The means by which a “yes” determination is reached is not particularly limited, and can depend on the nature of the application executed at block 310. In the present illustrative example, a “no” determination is made as there has been no input indicating that the “locked” state for apparatus 50 should be terminated. Accordingly, the “no” determination leads to block 325.

Block 325 comprises associating object(s) with at least one input instruction. Expressed in other words, block 325 contemplates that one or more of the graphical objects generated at block 315 are now associated with input behaviours associated with FSID 64. In the specific example of application 124, block 325 comprises associating unlock slider 204-2 graphical object with input instructions that can be received from FSID 64. If we assume that the states shown in FIG. 4, FIG. 5 and FIG. 6 are all available, then programming actions associated with unlock slider 204-2 can then be associated with the respective three different power levels P.

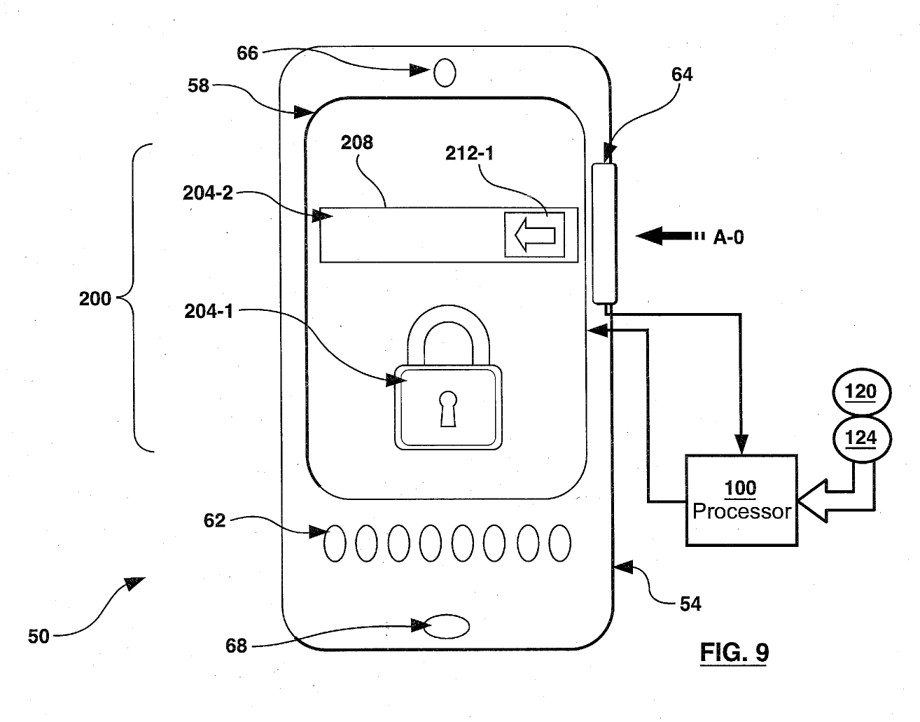

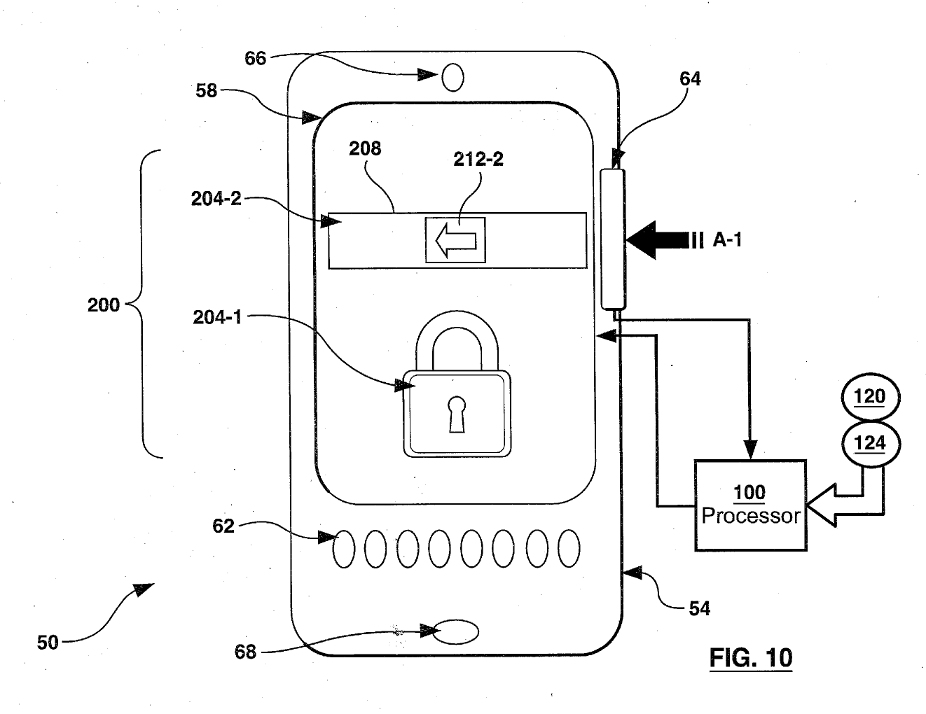

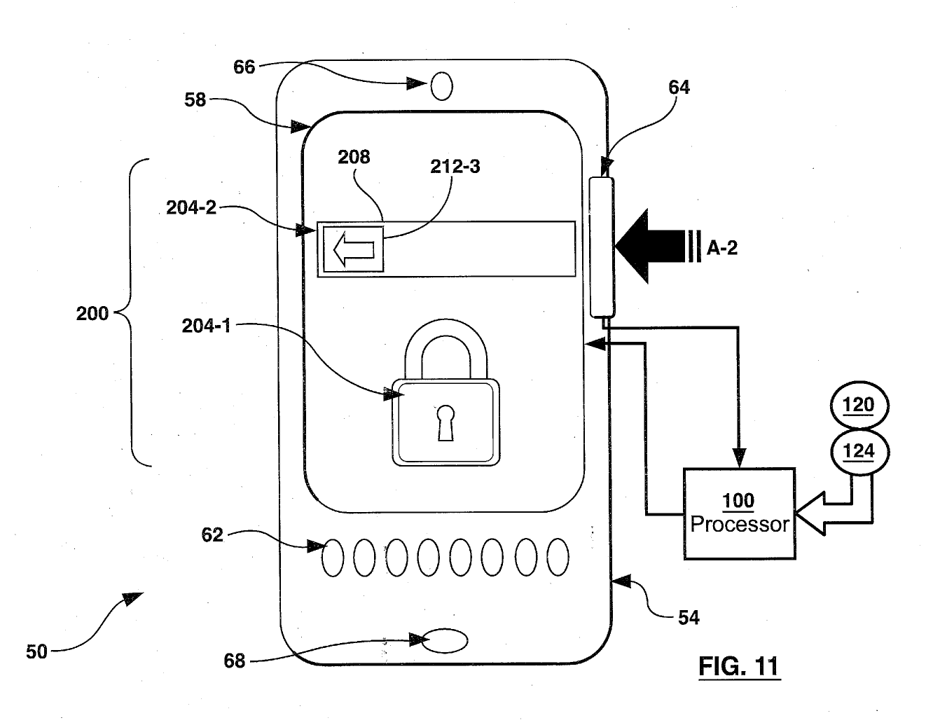

Accordingly, and referring now to FIG. 9, it will be assumed that follower 212-1, located to the far right of channel 208, is associated with force level A-0 and its corresponding power level P-0. Likewise, and referring now to FIG. 10, it will be assumed that follower 212-2, located to the middle of channel 208, is associated with force level A-1 and its corresponding power level P-1. Likewise, and referring now to FIG. 11, it will be assumed that follower 212-3, located to the far left of channel 208, is associated with force level A-2 and its corresponding power level P-2.

Block 330 comprises receiving an input representing an applied force. In relation to apparatus 50, block 330 contemplates actually receiving an input signal from FSID 64 at processor 100, such as one of the three states shown in FIG. 3, FIG. 4 and FIG. 5, which are also reproduced now in FIG. 9, FIG. 10 and FIG. 11 respectively.

Block 335 comprises determining an instruction based on the received input and the current state of the application. In the example application states shown in FIG. 9, FIG. 10 and FIG. 11, block 335 includes assessing which one of the application states correspond with the input received at block 335.

Block 340 comprises updating the state of the application based on the determined instruction. In the example application states shown in FIG. 9, FIG. 10 and FIG. 11, block 340 comprises updating unlock slider 204-2 to include follower 212-1 from FIG. 9 when there is a zero applied force A-0; or updating unlock slider 204-2 to include follower 212-2 from FIG. 10 when there is an intermediate applied force A-1; or updating unlock slider 204-3 to include follower 212-3 from FIG. 11 when there is high applied force A-2.

At this point method 300 returns to block 315, at which point the display is controlled to generate object(s) according to the current state of the application. The skilled reader will now appreciate that method 300 can be used, in relation to application 124, to cause processor 100 to control display 58 to generate objects 204, and in particular to cause: follower 212 to appear as follower 212-1 in FIG. 9 if no force A-0 is applied to FSID 64; follower 212 to appear as follower 212-2 in FIG. 10 if an intermediate level of force A-1 is applied to FSID 64; and follower 212 to appear as follower 212-3 in FIG. 11 if an high level of force A-2 is applied to FSID 64.

In a practical implementation of application 124, block 320 can be configured to make a “yes” determination if force A-2 is applied for a predetermined period of time, thereby ending application 124 and “unlocking” apparatus 50 for other uses.

It is to be understood that modifications, variations, enhancements and combinations thereof are contemplated. For example, while the foregoing example in relation to application 124 contemplates three discrete states, it should be understood that FSID 64 can be configured to operate so as to generate a continuous range of signals rather than a discrete range of signals, such that a plurality of power signals can be generated by FSID 64, each proportional to a plurality of different applied forces to FSID 64. Accordingly, method 300 can be implemented so that follower 212 is shown to reflect that plurality of different applied forces.

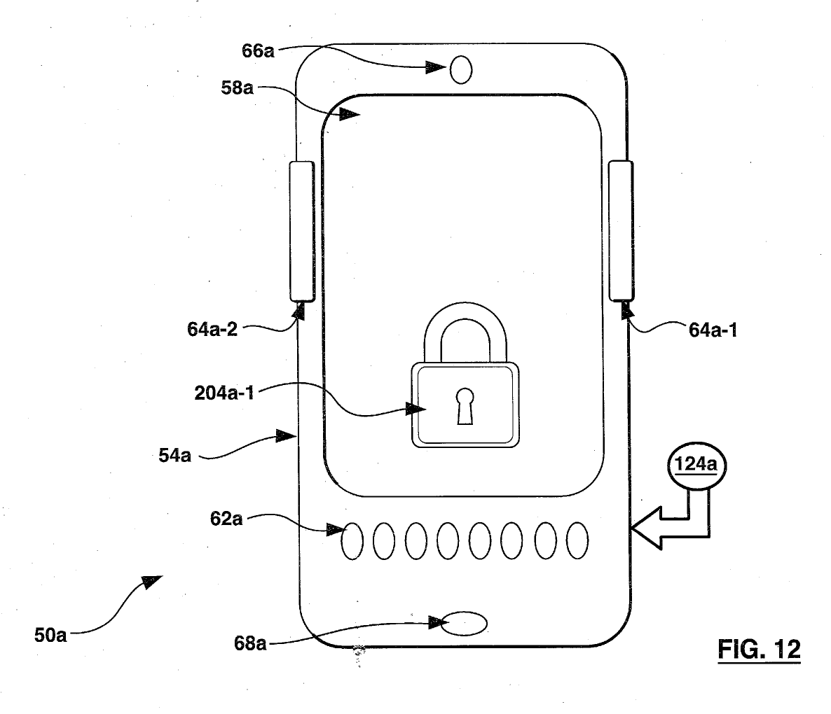

Another example variation is shown in FIG. 12 which shows a portable electronic apparatus 50a. Apparatus 50a is a variant on apparatus 50, and like components bear like references except followed by the suffix “a”. (For convenience, processor 100 is omitted from FIG. 12, but the skilled reader will now appreciate its role in apparatus 50a.) Of note is that apparatus 50a includes two FSIDs 64a. FSID 64a-1 is substantially the same as FSID 64, however apparatus 50a includes a second FSID 64a-2 which provides an associated power output signal to processor 100 in addition to that provided by FSID 64a-1.

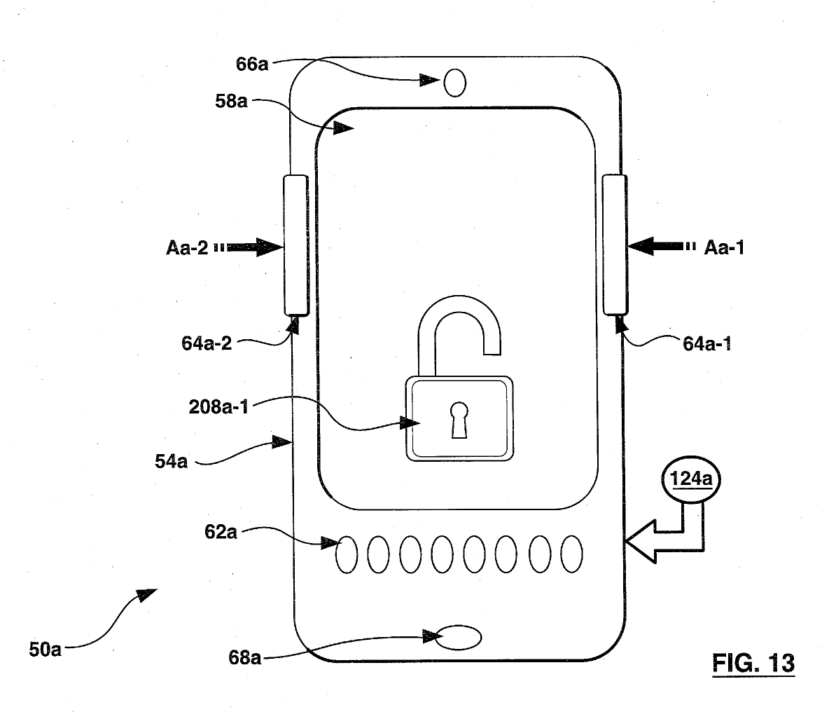

Apparatus 50a also executes application 124a that also holds apparatus 50a in a locked state to restrict inadvertent or unauthorized use of apparatus 50a. Application 124a is thus a variant of application 124 and comprises a padlock 204a-1 graphic object. Apparatus 50a is thus configured to receive a squeeze-type gesture input, whereby a force applied to FSID 64a-1, and an opposite force applied to FSID 64a-2, can be received as an input instruction at processor 100 as part of an unlock instruction. Apparatus 50a can be configured so that a predetermined amount of squeezing force is required in order to unlock apparatus 50a; a squeezing force below such a threshold is not sufficient to place apparatus 50a in the unlocked state. The unlock state is represented in FIG. 13, whereby a force Aa-1 applied to FSID 64a-1, and an opposite force Aa-2 applied to FSID 64a-2, each of sufficient magnitude, results in placing apparatus 50a in an unlock state, with an unlocked padlock 208a-1 graphic object as a graphical indicator that a sufficient squeezing force has been applied. Those skilled in the art will now recognize how method 300 can be utilized to effect the teachings of FIG. 12 and FIG. 13.

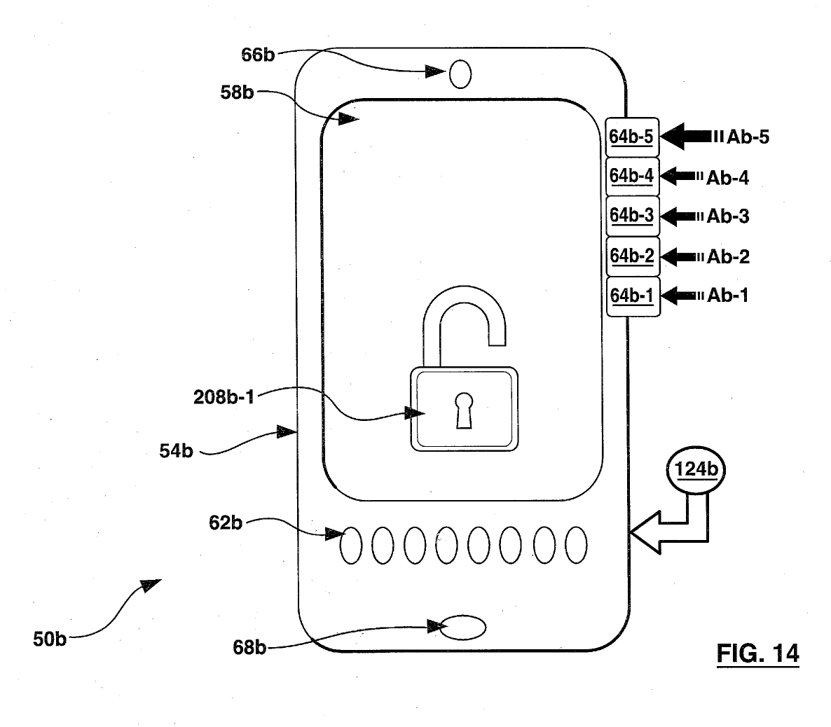

Another example variation is shown in FIG. 14 which shows a portable electronic apparatus 50b. Apparatus 50b is a variant on apparatus 50a, and like components bear like references except followed by the suffix “b” instead of “a”. Of note is that apparatus 50b includes five FSIDs 64b; each connected to processor 100 (not shown in FIG. 14) and providing respective power signals thereto. In apparatus 50b, method 300 is configured to unlock apparatus 50b upon detection of a swipe gesture effected by, for example, applying a thumb-sweep beginning by applying, a force Ab-1 to FSID 64b-1 and, progressively applying a force Ab-2 to FSID 64b-2, then a force Ab-3 to FSID 64b-3, and so forth, culminating in the application of a force Ab-5 to FSID 64b-5. FSIDs 64b are, as part of block 325, associated with locked padlock 204a-1 graphical object. Collectively, the applications of force Ab in FIG. 14 are referred to herein as “rub gestures”. As used herein a rub gesture comprises a variable force component and a directional component, as distinguished from a swipe gesture which only has a directional component.

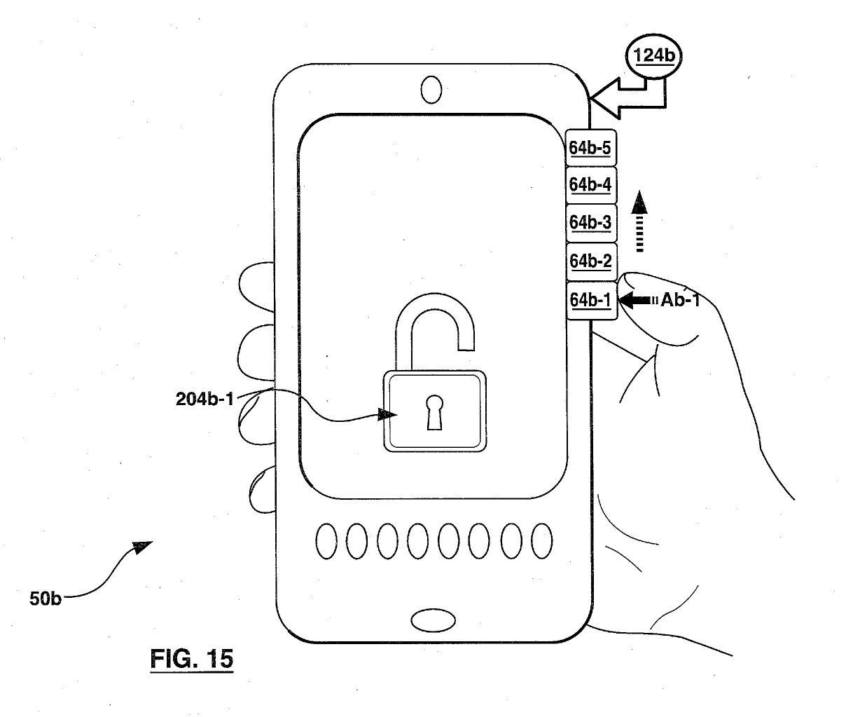

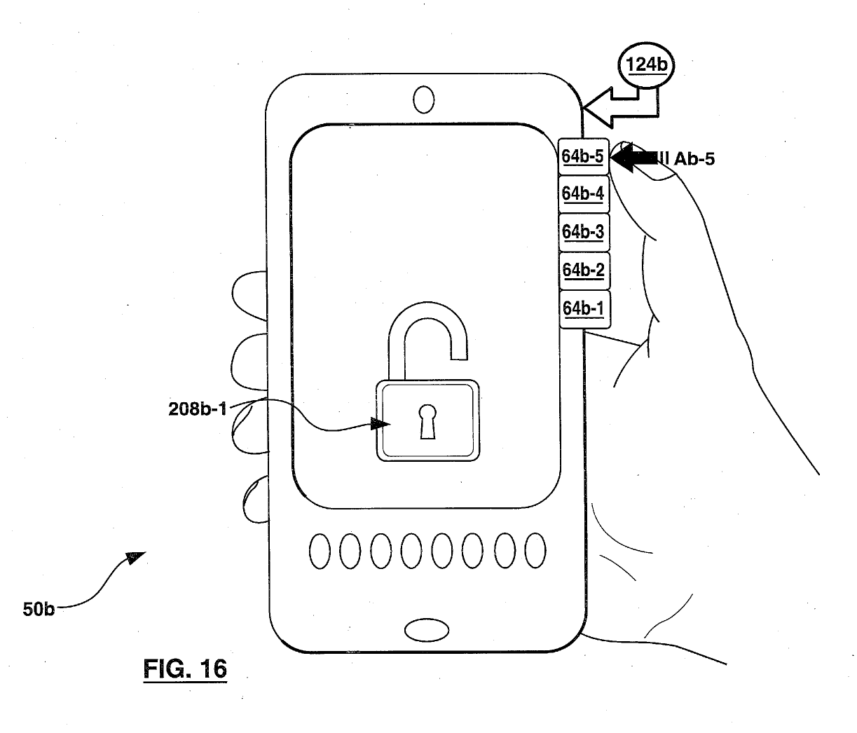

In a present non-limiting example embodiment, apparatus 50b is configured so that force Ab-5 must be greater than the remaining forces Ab. The initial stage of this gesture is also represented in FIG. 15, while the final stage of this gesture is represented in FIG. 16. Advantageously, the likelihood of inadvertent actions (e.g. dropping; storing apparatus 50b in a pocket) resulting in unintentional unlocking of apparatus 50b is reduced by configuring apparatus 50b to respond as described above.

In general terms, apparatus 50b introduces the fact that the present invention also contemplates modifying block 325, block 330 and block 335 to not only process inputs representing applied forces, and varying levels of applied forces, but to also to process inputs representing time and position signals associated with actuation of FSIDs 64b.

At this point it can also be noted that while apparatus 50b contemplates a plurality of discrete FSIDs 64b, apparatus 50b can be modified to incorporate, for example, FSR strip sensors such as those provided by Interlink Electronics, and still provide the same functionality of apparatus 50b. In that event, a single FSR strip sensor can be used in place of the plurality of FSIDs 64b shown in FIG. 14, FIG. 15, and FIG. 16. It can also be noted that a single FSR strip sensor of the type provided Interlink Electronics Inc. can provide analog output such that a continuous range of positions along the length of the strip can be detected, in addition to the amount of force being applied at that position. (The number of positions that are detectable being a function of the resolution of an analog to digital circuit that is used to decode the signals being received from the single FSR strip.)

The skilled reader will now appreciate that apparatus 50b can be combined with concepts of apparatus 50a, whereby a plurality of FSIDs 64b (or a single strip FSR) are disposed along each side of apparatus 50b to accommodate detection of a pair of swipe gesture that culminate in a squeeze gesture like that shown in relation to apparatus 50a.

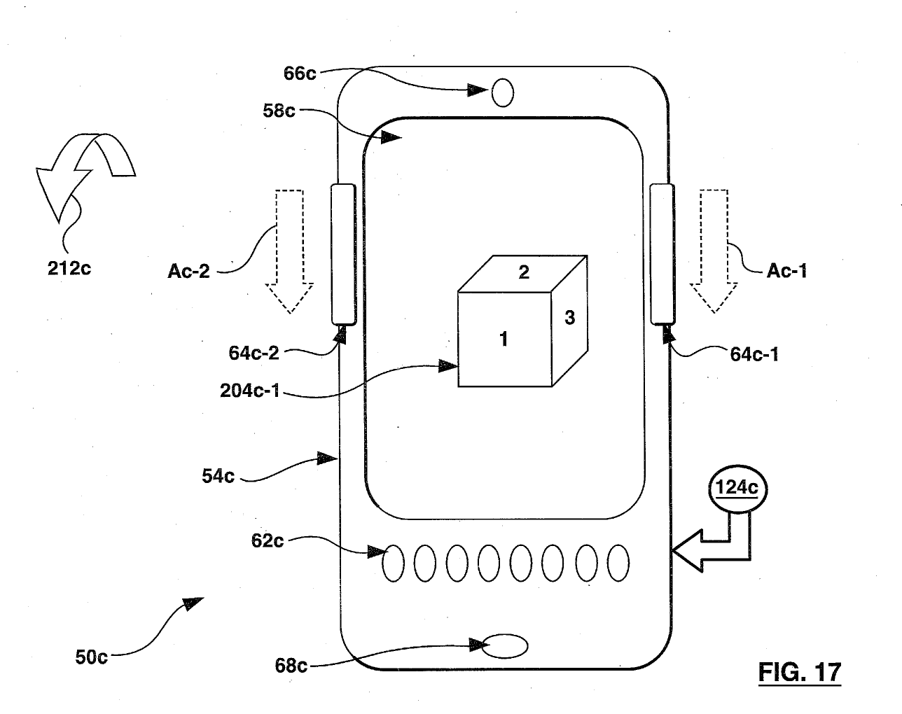

Another example variation is shown in FIG. 17 which shows a portable electronic apparatus 50c. Apparatus 50c is a variant on apparatus 50b, and like components bear like references except followed by the suffix “c” instead of “b”. Of note is that apparatus 50c comprises a pair of FSIDs 64c. FSIDs 64c, in a present embodiment, are implemented as strip FSRs, thereby providing them with substantially the same functionality as the plurality of FSIDs 64b on apparatus 50b. Also of note is that application 124c comprises a graphic object viewer functionality. In the example of FIG. 17, a cube 204c-1 graphical object is shown on display 58c from a first angle, with the side labeled “1” facing forward, and the side labeled “2” facing upward. (It is to be understood that the cube is just an example; any graphical object or image can be used.)

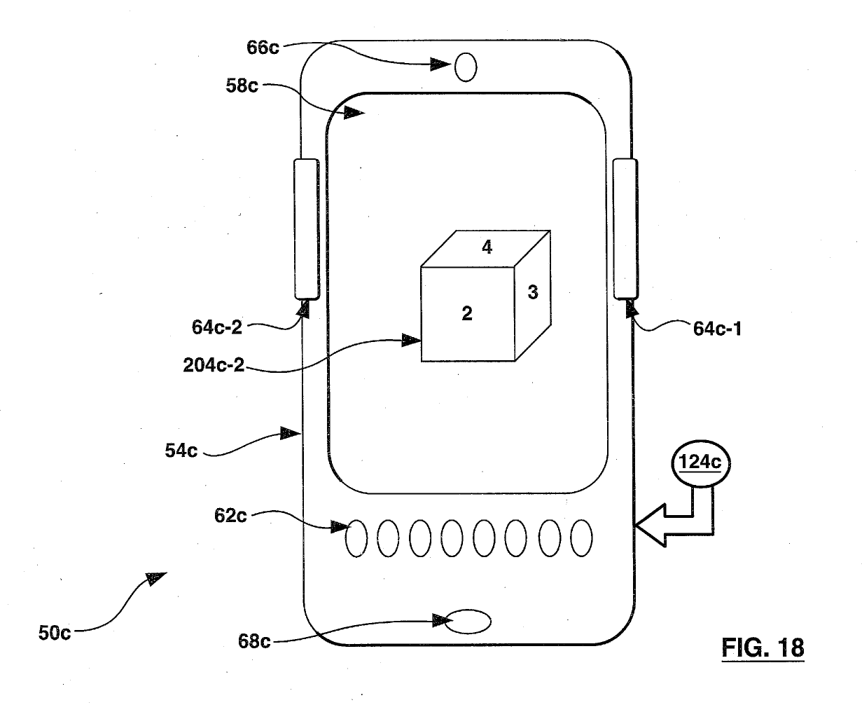

FIG. 18 also shows device 54c, but in FIG. 18c cube 204c-1 graphical object has been rotated to the position shown in FIG. 18. Cube 204c-1 has been rotated from the first viewing angle in FIG. 17, to the second viewing angle in FIG. 18. Note that FIG. 18 shows a second cube 204c-2 graphical object, with the side labeled “2” now facing forward, and the side labeled “4” now facing upward; the said labeled “1” (not shown) now facing downward. The change in view from cube 204c-1 in FIG. 17 to the view of cube 204c-2 in FIG. 18 can be effected by way of a unique rub gesture; presently contemplated to comprise two substantially parallel rub gestures Ac in a first direction, namely downward, which together provide a rotational viewing instruction consistent with the arrow 212c in FIG. 17. For convenience, rub gestures Ac-1 and Ac-2 are simply shown as down arrows, but it is to be understood that when applying method 300 to apparatus 50c, satisfying the receiving input block 330 of method 300 includes also detecting one or more threshold levels of inwardly applied force, consistent with, for example, the rub gestures Ac discussed in relation to FIG. 15 and FIG. 16.

It will now be apparent that apparatus 50c can also be configured to accept other rub gestures. For example, rub gestures made in the opposite direction of rub gestures Ac, or upward rub gestures, can be used to configure apparatus 50c so that display 58c shows a corresponding rotation from the view of cube 204c-2 in FIG. 18 to the view of cube 204c-1 in FIG. 17.

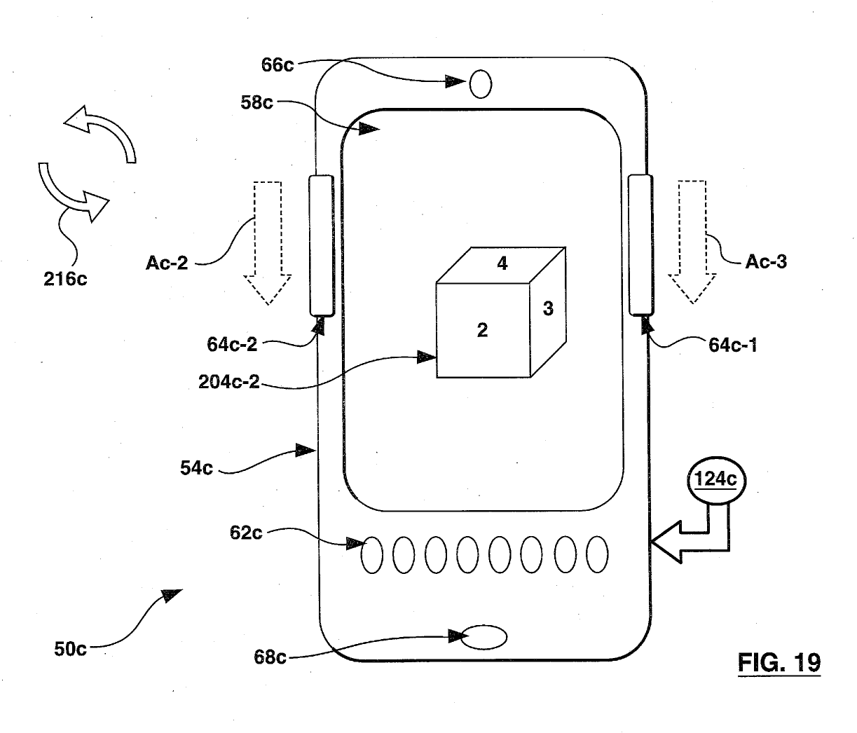

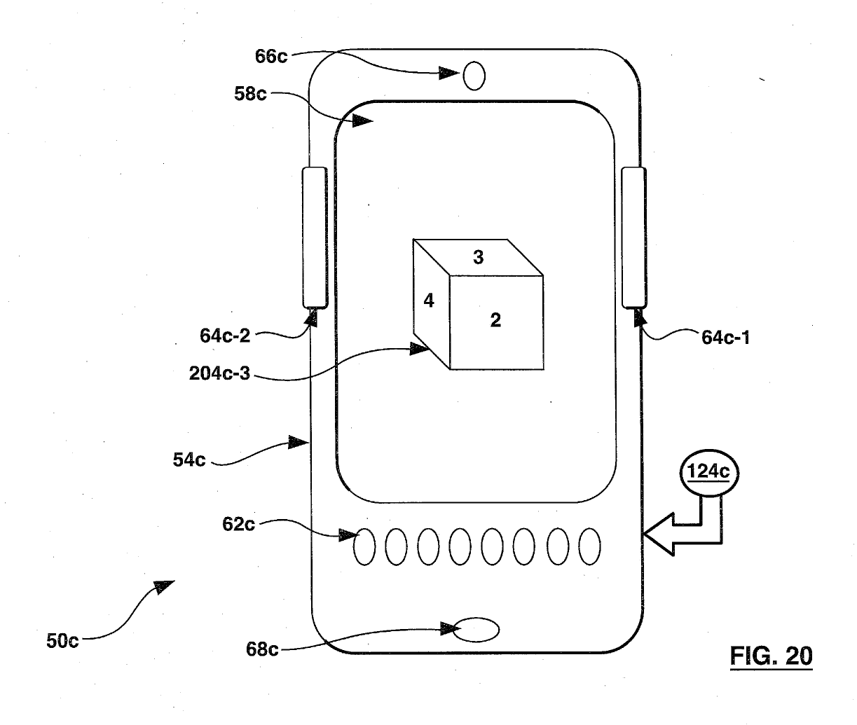

FIG. 19 also shows apparatus 50c, but in FIG. 19 cube 204c-2 graphical object is being rotated to the position shown in FIG. 20. Expressed in other words, cube 204c-2 is being rotated from the second viewing angle in FIG. 19, to a third viewing angle in FIG. 20. Note that FIG. 20 shows a third cube 204c-3 graphical object, with the side labeled “2” facing forward, but rotated ninety-degrees and the side labeled “4” now facing to the left, the side labeled “1” (not shown) now facing to the right, and the side labeled “3” now facing upward. The change in view from cube 204c-2 in FIG. 19 to the view of cube 204c-3 in FIG. 20 can be effected by way of other unique rub gestures, presently contemplated to comprise two substantially opposite rub gestures, comprising as shown in FIG. 19, rub gesture Ac-2 in a first direction, namely downward, and rub gesture Ac-3 in a second direction, namely upward, which together provide a rotational viewing instruction at block 330 and block 335 consistent with the arrow 216c.

Apparatus 50c can be configured so that rub gesture Ac-2 and rub gesture Ac-3 need to be performed substantially at the same time, or within some predefined time period of each other, in order to constitute an input instruction at block 335. For convenience, rub gestures Ac-2 and Ac-3 are simply shown as arrows, but it is to be understood that when applying method 300 to apparatus 50c, satisfying the receiving input block 330 of method 300 includes also detecting one or more threshold levels of inwardly applied force, consistent with, for example, the rub gestures Ac discussed in relation to FIG. 19 and FIG. 20. Such rub gestures can include a requirement for a substantially consistent level of force, above a predefined threshold, or can include a requirement for some defined changing level of force.

It will now be apparent that apparatus 50c can also be configured to accept additional rub gestures. For example, applying rub gesture Ac-3 to FSID 64c-2, and rub gesture Ac-2 to FSID 64c-1, effectively reversing the gestures in FIG. 19, can be used to result in a corresponding rotation from the view of cube 204c-3 in FIG. 20 to the view of cube 204c-2 in FIG. 19.

It is to be reiterated that the rub gestures described in relation to apparatus 50c can be associated with different rotational or other navigational viewing instructions; the specific associations discussed in relation to apparatus 50c are non-limiting examples.

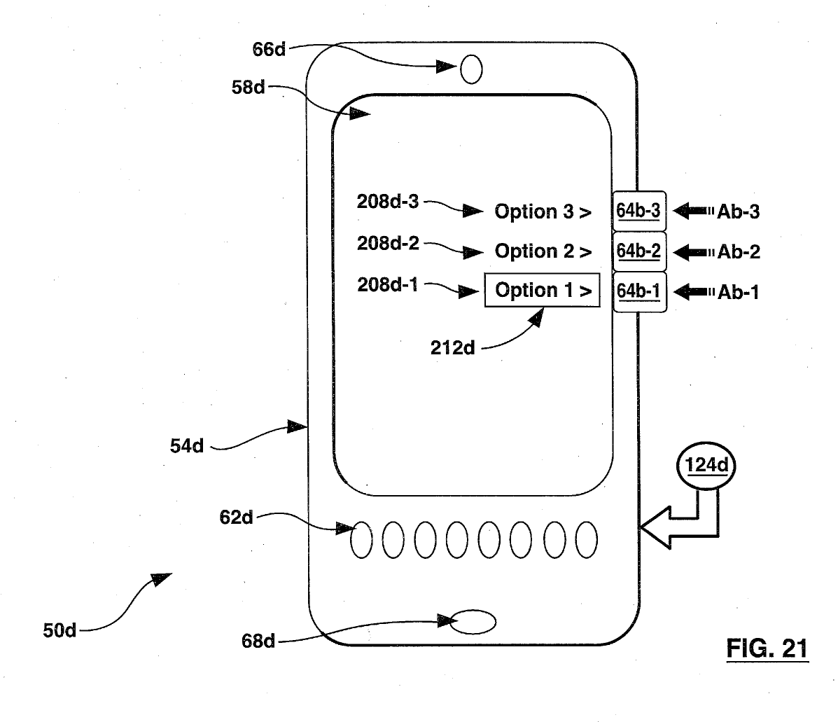

Another example variation is shown in FIG. 21 which shows a portable electronic apparatus 50d. Apparatus 50d is a variant on apparatus 50b, and like components bear like references except followed by the suffix “d” instead of “b”. In apparatus 50d, application 124d is a menu selection application that includes a plurality of options. Apparatus 50d includes three FSIDs 64d, which as noted above can, though need not be, implemented as an FSR strip. Apparatus 50d contemplates three graphical objects in the form of option headings 208d, namely Option 1 heading 208d-1; Option 2 heading 208d-2 and Option 3 heading 208d-3. The presently selected option heading 208d, in this example currently Option 1 heading 208d-1, is highlighted via a highlighting effect 212d which is implemented in the present example as a box that surrounds option 1 heading 208d-1. It will be understood that fewer or more FSIDs 64d and fewer or more option headings 208d can be included.

When method 300 is used to operate device 30d, FSIDs 64d each become associated with their respective option heading 208d. A first threshold level of force Ad applied to a respective FSID 64d associates highlight effect 212d with the corresponding option heading 208d. A second level of force (higher than the first level of force Ad) applied to the currently highlighted option heading 208d is associated with an instruction to actually invoke an action associated with the highlighted option heading 208d.

In an example variation, apparatus 50d can be configured to show graphical object in the form of a map or other image (not shown), and the option headings 208d can be each associated with different zooming functions. For example, option 1 heading 208d-1 can be associated with a zoom-out function and option 3 heading 208d-3 can be associated with a zoom-in function. Tapping a respective FSID 64d will cause a corresponding zoom-in or zoom-out at a predefined level (e.g. by 25 percent). When pressing and holding a given FSID 64d, the rate of zoom can be configured to vary according to the amount of force applied to a given FSID 64d. The skilled reader will now appreciate that panning functions can likewise be implemented used FSIDs, whereby, for example, the rate of panning increases according to the amount of force that is applied.

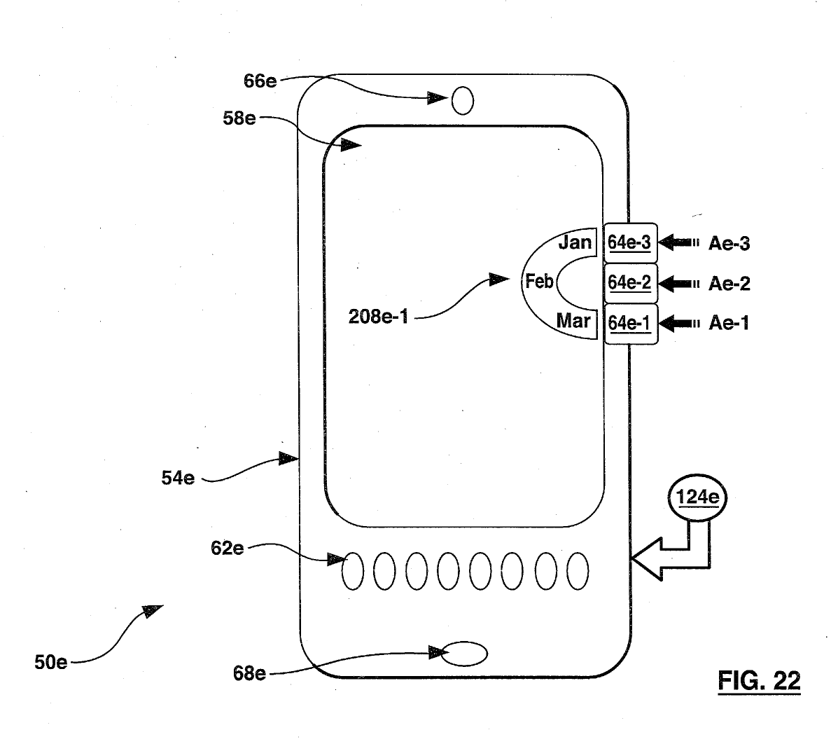

Another example variation is shown in FIG. 22 which shows a portable electronic apparatus 50e. Apparatus 50e is a variant on apparatus 50d, and like components bear like references except followed by the suffix “e” instead of “d”. In apparatus 50e, application 124e is a wheel-selector application that includes a plurality of options, presently in the form of months of the year. Apparatus 50e includes three FSIDs 64e, which as noted above can, though need not be, implemented as an FSR strip. Apparatus 50e contemplates a graphical object in the form of a wheel 208e-1. The presently selected option is the month of February due to its central location on wheel 208e-1.

Apparatus 50e can be configured so that an application of a first level of force Ae-1 to FSID 64e-1 causes wheel 208e-1 to rotate in a counter-clockwise direction bringing the month of February downward; an application of a first level of force Ae-3 to FSID 64e-3 causes wheel 208e-1 to rotate in a clockwise direction bringing the month of February upward. An application of a first level of force Ae-2 to FSID 64e-2 causes an invocation of an action associated with the correspondingly displayed month. In a further variation, apparatus 50e can be configured so that an upward swipe from FSID 64e-1 towards FSID 64e-2 would be interpreted as an instruction to rotate wheel 208e-1 in a first direction (e.g. clockwise); while a downward swipe (e.g. a rub gesture applied with substantially consistent force, or a force substantially consistently above a predefined threshold level.) from FSID 64e-3 towards FSID 64e-1 is interpreted as an instruction to rotate wheel 208e-1 in a second direction (e.g. counter-clockwise); while an inward force Ae at a respective FSID 64e is interpreted as an instruction to invoke an action associated with the month currently displayed adjacent to that FSID 64e.

The speed of such rotations of wheel 208e-1 can also vary according to the amount force applied. Apparatus 50e can also be varied to include opposing sets of FSIDs 64e (much the way apparatus 50c includes FSID 64c-2 and FSID 64c-1), and another set of swipe, or rub gestures can be associated with wheel 208e-1 therewith.

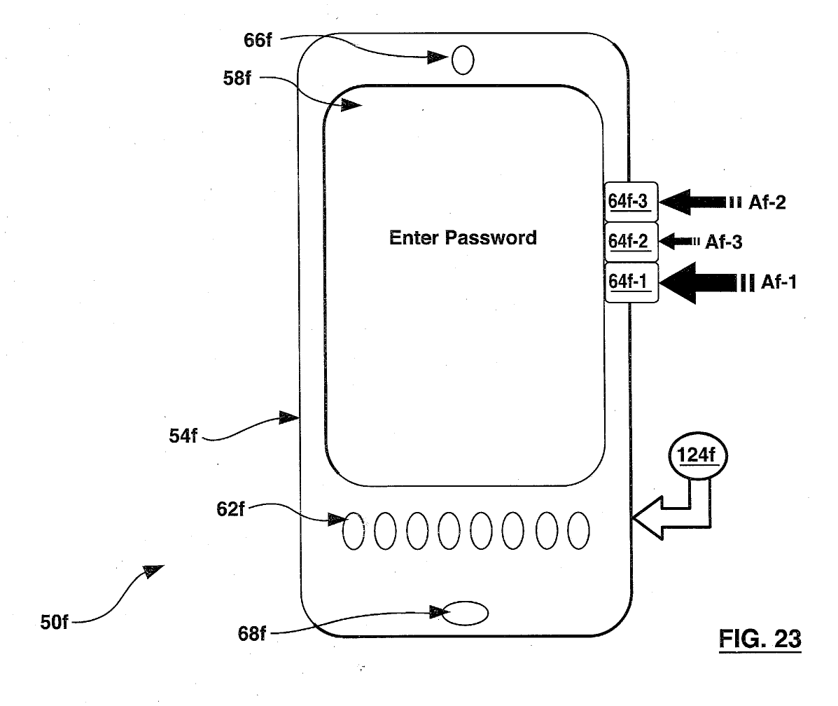

Another example variation is shown in FIG. 23 which shows a portable electronic apparatus 50f. Apparatus 50f is a variant on apparatus 50e, and like components bear like references except followed by the suffix “f” instead of “e”. In apparatus 50f, application 124f is a password entry screen that includes a textual graphical object 208f-1, in the form of an instruction to enter a password. Apparatus 50f includes three FSIDs 64f, which as noted above can, though need not be, implemented as an FSR strip. Apparatus 50f contemplates that a password can be associated with a unique set and sequence of forces Af applied to one or more of FSIDs 64f. In the example of FIG. 23, the sequence is set to the reception of a first level of force Af-1 applied to FSID 64f-1; then the reception of a second level of force Af-2 applied to FSID 64f-3, and then a third level of force Af-3 applied to FSID 64f-2.

While not shown in FIG. 23, further graphical objects that can be associated with instructions received via FSIDs 64f can include one more visual meters, showing the level of force Af being applied to one or more respective FSIDs 64f. These visual meters can assist in providing feedback that a particular level of force Af is actually being detected. Note that application 124f can likewise include a set password screen which can be used to actually set the sequence of forces Af that constitute the password.

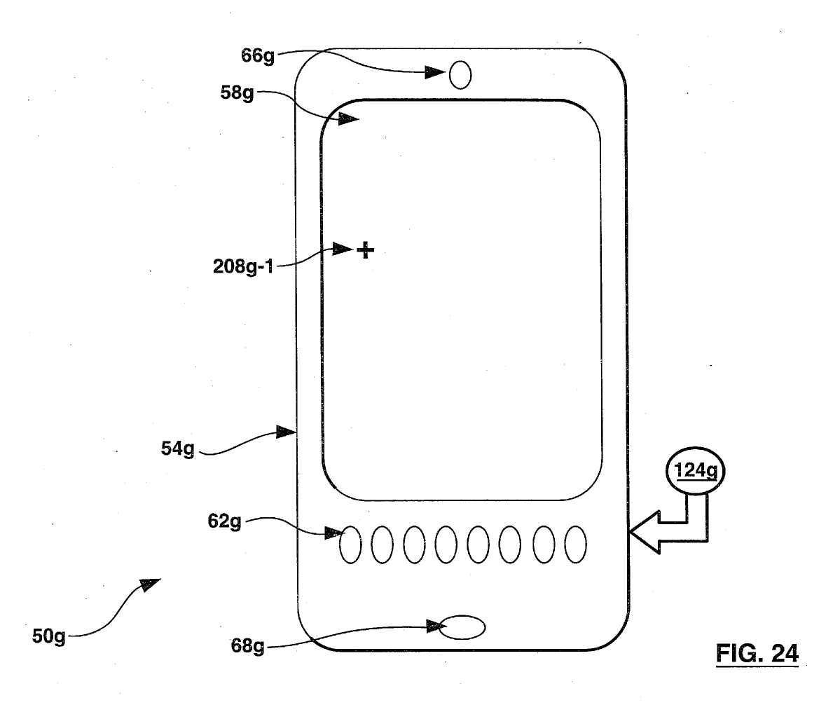

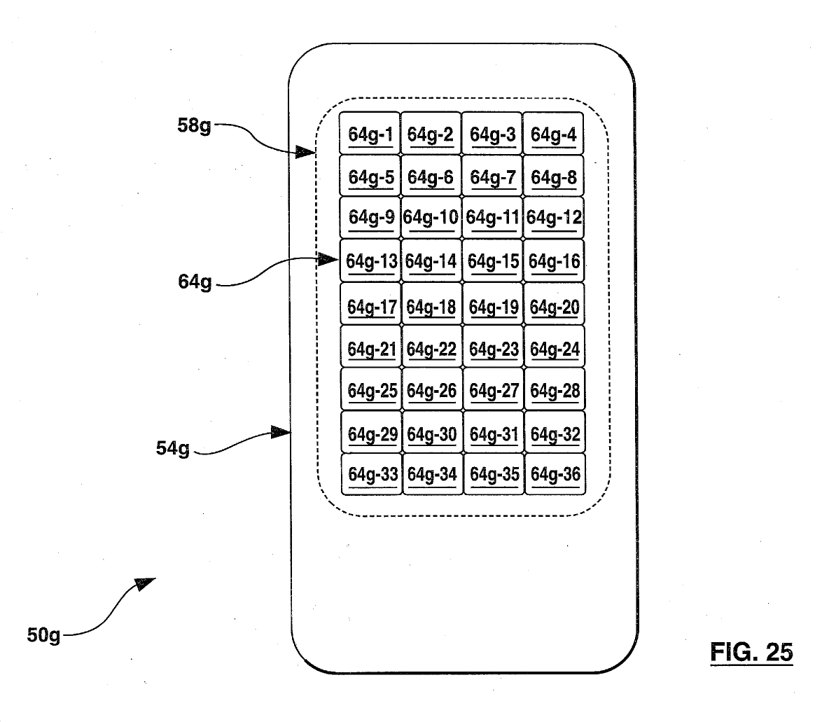

Another example variation is shown in FIG. 24 and FIG. 25 which shows a portable electronic apparatus 50g. Apparatus 50g is a variant on apparatus 50f, and like components bear like references except followed by the suffix “g” instead of “f”. FIG. 24 is a front view of apparatus 50g, while FIG. 25 is a rear view of apparatus 50g. Referring to FIG. 24, in apparatus 50g application 124g is pointing application that includes a graphical object in the form of a mouse pointer 208g-1, which can be moved about the area of display 58g. Referring to FIG. 25, a plurality of FSIDs 64g cover the area of the back of apparatus 50g over an area the corresponds to the area covered by display 58g. Note that FSIDs 64g could be implemented as a plurality of FSR strips, or even a single FSR sheet, with appropriate post-processing so that an application of force to a given area corresponding to an individual FSID 64g can be detected and quantified.

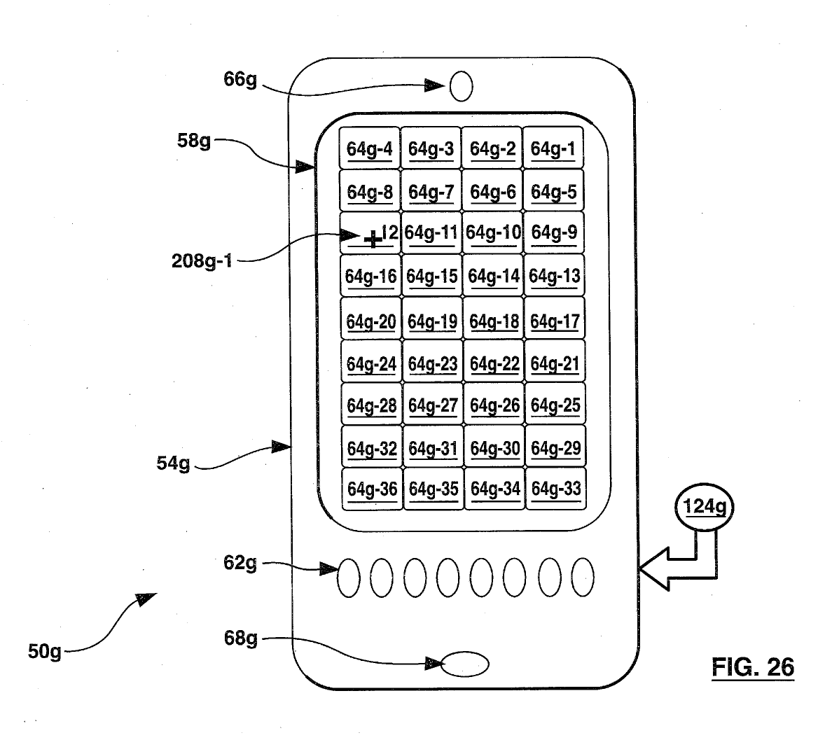

Referring now to FIG. 26, it can be seen that application 124g contemplates that when a first level of force is applied to a given FSID 64g (E.g. FSID 64g-12) then mouse pointer 208g-1 will be brought into an area of focus on display 58g that matches the location as the relevant FSID 64g-12. Application 124g contemplates that when a second level of force is applied to a given FSID 64g where a mouse pointer 208g-1 is in focus, then an action associated with that area of the display 58g will be invoked; akin to pointing and clicking a regular mouse. The second level of force can be different or equal to the first level of force. Apparatus 50g can be configured so that the second level of force needs to be applied for a predetermined period of time before deeming that a selection or an invocation instruction as been received.

The skilled reader will now appreciate that FSIDs 64g effectively function as a trackpad. Variations thus contemplate that FSIDs 64g need not be positioned in the exact configuration shown in FIG. 26, but could be positioned or mounted on device 64g in another location. While the foregoing provides certain non-limiting example embodiments, it should be understood that combinations, subsets, and variations of the foregoing are contemplated. The monopoly sought is defined by the claims. For example, while method 300 has been described in relation to graphical objects, it is to be understood that method 300 can be modified for audible objects that emanate from speaker 66 or stereo speakers (not shown). For example, audio tone (treble/bass) could be adjusted via rub gestures and balance could be adjusted via a squeeze gesture, etc.

Likewise haptic objects are also contemplated. As another example, the skilled reader will also now appreciate that while FSID 64 can be used for force gestures, and rub gestures, FSIDs 64 can also be used for traditional swipe gestures by interpreting any rub gesture that exceeds a certain force threshold as satisfying criteria for a swipe gesture.

Various advantages will now be apparent. For example, the present invention provides a wide range of possible novel types of gesture inputs which can be implemented using FSID. Such an increase in a range of gesture inputs can increase usability and intuitiveness of operation. By the same token, the use of FSRs, or other types of FSIDs, can be advantageous for ruggedized and/or waterproof packaging for an electronic apparatus, while still provide the possibility for different gesture-type inputs.

1. A method for controlling a display of an electronic apparatus in response to an input from a force sensitive input device (FSID) comprising:
controlling said display to generate a first graphical object;
associating said first graphical object with an instruction;
receiving an input representing an applied force at said FSID;
determining receipt of said instruction based on said input from said FSID; and,
controlling said display to generate a second graphical object different from said first graphical object in response to said determined instruction.

2. The method of claim 1 further comprising performing an additional instruction in association with said input.

3. The method of claim 2 wherein said additional instructions comprises one of an unlock command, a zoom command or a pan command.

4. The method of claim 1 wherein said second graphical object is an animation of said first graphical object.

5. The method of claim 1 wherein said associating comprises associating said first graphical object with a plurality of input instructions from said FSID and wherein said determining comprises determining one of a plurality of potential instructions based on a match between said input and one of said plurality of input instructions.

6. The method of claim 1 wherein said FSID is a force sensitive resistor.

7. The method of claim 1 wherein said FSID comprises a plurality of FSIDs.

8. The method of claim 7 wherein said input comprises a swipe gesture having a directional component.

9. The method of claim 7 wherein said input comprises a rub gesture having a directional component and a variable force component.

10. The method of claim 7 wherein said FSIDs are implemented using a strip force sensitive resistor.

11. The method of claim 7 wherein said plurality of FSIDs are coplanar with said display.

12. An electronic apparatus comprising:
a display;
a processor connected to said display for controlling said display to generate a first graphical object and for associating said first graphical object with an instruction;
a force sensitive input device (FSID) connected to said processor for providing input to said processor that represents an applied force to said FSID; and,
said processor further configured to determine receipt of said instruction based on said input and to control said display to generate a second graphical object different from said first graphical object in response to said instruction.

13. The apparatus of claim 12 wherein said processor is further configured to perform an additional instruction in association with said input.

14. The apparatus of claim 12 wherein said second graphical object is an animation of said first graphical object.

15. The apparatus of claim 12 wherein said FSID comprises a plurality of FSIDs.

16. The apparatus of claim 18 wherein said input comprises a swipe gesture having a directional component.

17. The apparatus of claim 18 wherein said input comprises a rub gesture having a directional component and a variable force component.

18. The apparatus of claim 18 said FSIDs are implemented using a strip force sensitive resistor.

19. The apparatus of claim 18 wherein said plurality of FSIDs are coplanar with said display.

20. An electronic apparatus comprising:
an output device;
a processor connected to said display for controlling said device to generate a first output object and for associating said first output object with an instruction;
a force sensitive input device (FSID) connected to said processor for providing input to said processor that represents an applied force to said FSID; and,
said processor further configured to determine receipt of said instruction based on said input and to control said output device to generate a second output object different from said first output object in response to said instruction.
